(19) United States
(12) Patent Application Publication
(10) Pub. No.: US 2015/0277858 A1
(43) Pub. Date: Oct. 1, 2015

(54) PERFORMANCE EVALUATION DEVICE, METHOD, AND MEDIUM FOR INFORMATION SYSTEM

(71) Applicant: NEC CORPORATION, Minato-ku, Tokyo (JP)

(72) Inventor: Hiroshi Sakaki, Tokyo (JP)

(21) Appl. No.: 14/430,619

(22) PCT Filed: Sep. 17, 2013
(86) PCT No.: PCT/JP2013/005470

§ 371 Date: Mar. 24, 2015

(30) Foreign Application Priority Data
Oct. 2, 2012 (JP) 2012-220619

(51) Int. Cl. G06F 9/44

(52) U.S. Cl. CPC G06F 8/20; G06F 8/10

(57) ABSTRACT

To evaluate the performance of an information system having an undeveloped portion with precision. The information system performance evaluation device comprises: an operation information acquisition unit that, when an execution instruction of a performance evaluation is input, acquires the operation information of an existing system constructed using the same system model as the one of the system to be evaluated from an operation information DB, on the basis of the system model of the system to be evaluated; an undeveloped portion extraction unit that extracts parameters corresponding to modules of an undeveloped portion of the system to be evaluated, among the modules to be incorporated thereinto, from the acquired operation information of the existing system; and a performance evaluation unit that evaluates the performance of the system to be evaluated using the extracted parameters and parameters corresponding to the developed modules of the system to be evaluated.

### TECHNICAL FIELD

The present invention relates to a performance evaluation device, method, and program for information systems.

### BACKGROUND ART

When developing an information system to be configured by a plurality of servers, evaluating the performance of the information system at a point when a part of modules is developed can enhance efficiency of the development. PTL1 below-described discloses a technique of constructing a system to be tested by incorporating a developing program in another proven program and evaluating the system to be tested by utilizing data of the other proven program.

### CITATION LIST

### Patent Literature

PTL1: Japanese Laid-open Patent Publication No. 2006-59108

### SUMMARY OF INVENTION

### Technical Problem

Meanwhile, with the technique disclosed in PTL1, as a system to be tested is actually executed and evaluated, the interfaces for a method of transferring data or the like need to perfectly match between the program under development and the other proven program.

In other words, if there is no program, of which interface perfectly matches with any one of the program under development, among the proven programs, the program under development cannot be evaluated until all the modules under development are completed.

The present invention has been made to solve the above-described problem. The present invention, as one of its objects, provides a performance evaluation device, a method, and a program for information systems, which can evaluate the performance of the information systems including undeveloped portions with precision.

### Solution to Problem

The performance evaluation device for an information system as an aspect of the present invention includes an input and output unit and a performance evaluation unit, wherein the performance evaluation unit evaluates performance of a system to be evaluated from operation information of an existing system that is constructed with a system model identical to the system model of the system to be evaluated that is input via the input and output unit, by using parameters corresponding to modules of an undeveloped portion of the system to be evaluated and parameters corresponding to developed modules of the system to be evaluated among modules to be incorporated into the system to be evaluated.

The performance evaluation method for an information system as an aspect of the present invention includes: acquiring parameters corresponding to modules of an undeveloped portion of the system to be evaluated and parameters corresponding to developed modules of the system to be evaluated among modules to be incorporated into the system to be evaluated from operation information of an existing system that is constructed with a system model identical to the system model of the system to be evaluated; and evaluating performance of the system to be evaluated by using the acquired two parameters.

The performance evaluation program for an information system as an aspect of the present invention causes a computer to execute processing of: acquiring parameters corresponding to modules of an undeveloped portion of the system to be evaluated and parameters corresponding to developed modules of the system to be evaluated among modules to be incorporated into the system to be evaluated, from operation information of an existing system that is constructed with a system model identical to the system model of the system to be evaluated; and evaluating performance of the system to be evaluated by using the acquired two parameters.

The above object can also be achieved with a computer readable recording medium that stores such a performance evaluation program for information systems.

### Advantageous Effects of Invention

According to the present invention, the performance of an information system including an undeveloped portion can be evaluated with precision.

### BRIEF DESCRIPTION OF DRAWINGS

FIG. 1 is a diagram exemplifying a configuration of a performance evaluation device for an information system according to the exemplary embodiment of the present invention;

FIG. 2 is a schematic view for describing the overview of the performance evaluation according to the exemplary embodiment of the present invention;

FIG. 3 is a flowchart for describing a procedure of the present invention for evaluating the performance of an information system; and

FIG. 4 is a block diagram illustrating an example of a hardware configuration of a performance evaluation device for an information system 1 according to the exemplary embodiment of the present invention.

### DESCRIPTION OF EMBODIMENTS

Hereinafter, an exemplary embodiment of the performance evaluation device, method, and program for information systems according to the present invention will be described with reference to the accompanying drawings.

The “performance evaluation device for an information system” (hereinafter, referred to as “performance evaluation device”) according to the present exemplary embodiment is a device for evaluating the performance of a variety of information systems. These information systems are constructed by using virtual machines in a cloud environment.

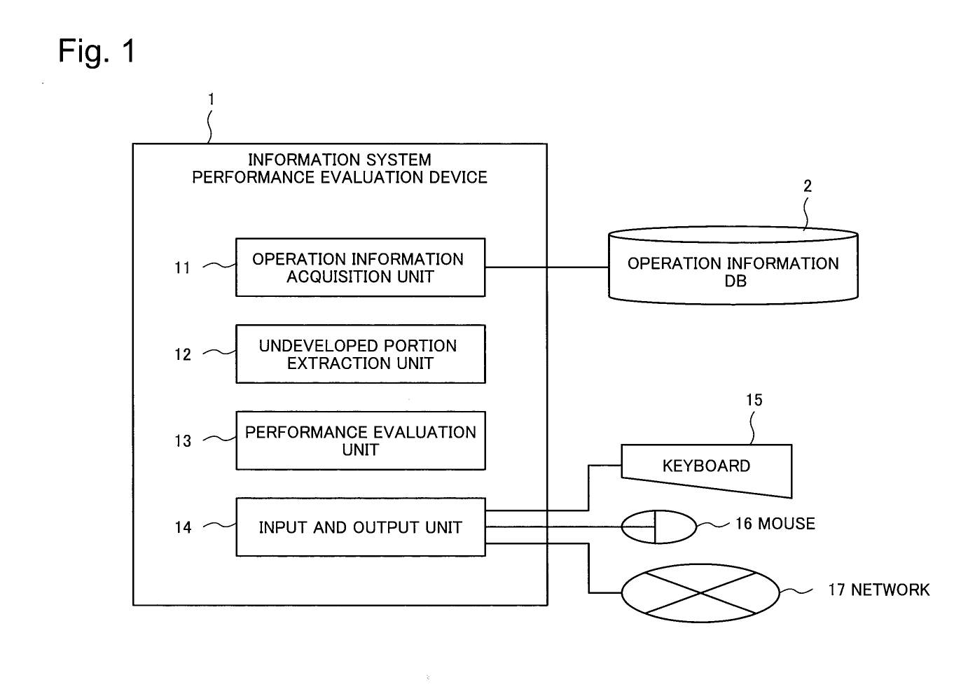

First, referring to FIG. 1, the configuration of the performance evaluation device according to the present exemplary embodiment will be described. As illustrated in FIG. 1, the “performance evaluation device for an information system 1” (hereinafter, referred to as “performance evaluation device 1”) functionally includes, for example, an operation information acquisition unit 11, an undeveloped portion extraction unit 12, a performance evaluation unit 13, and an input and output unit 14.

The input and output unit 14 inputs and outputs data with a keyboard 15 and a mouse 16, or by connecting with the outside via a network 17.

When an execution instruction of a performance evaluation is input by a user, the operation information acquisition unit 11 acquires, from an operation information “database 2” (hereinafter, referred to as “DB 2”) that stores the operation information of “already constructed information systems” (hereinafter, referred to as “existing system”) on the basis of the system model of the “information system to be subjected to performance evaluation” (hereinafter, referred to as “system to be evaluated”), operation information of an existing system that is constructed by using a system model identical to the system model of the system to be evaluated.

A system model is a model to be set for each unit of design information for constructing an information system.

The design information includes information describing, for example, a network configuration, a server configuration, a relationship among the components of applications, and processing flows that indicate operation of the applications, and the like

The operation information is information that is managed by an operator who operates the information system and includes, for example, parameters, such as the load of a CPU (Central Processing Unit), the number of processing requests, and a hard disk failure history, and the values of the parameters acquired from the operation system.

As parameters, for example, a request arrival rate and an average transmission size of application messages can be used. Further, as parameters, a Web load indicated by average CPU time, a Web reading load indicated by disc reading time, and a Web writing load indicated by disk writing time can be used. Furthermore, as parameters, an average size upon SQL execution, an application load indicated by average CPU time, and an application writing load indicated by disk writing time and the like can be used.

The operation information DB 2 is a database that stores operation information of an existing system and can also store parameters corresponding to developed modules of the system to be evaluated. The operation information DB 2 is designed such that the operation information or parameters can be searched using a system model as a key. The operation information DB 2 may be equipped either inside or outside the performance evaluation device 1.

The undeveloped portion extraction unit 12 extracts parameters corresponding to modules of the undeveloped portion, among the modules to be incorporated into the system to be evaluated, from operation information of the existing system acquired from the operation information acquisition unit 11. Here, “modules” are wording indicating a development application (functions) represented by a software program (a computer program).

The performance evaluation unit 13 evaluates the performance of the system to be evaluated by using parameters extracted by the undeveloped portion extraction unit 12 and parameters corresponding to the developed modules of the system to be evaluated.

The parameters corresponding to the developed modules are stored in the development environment along with the development application. Here, the parameters may be directly acquired from the system under development via the input and output unit 14 and be output to the performance evaluation unit 13. Alternatively, the parameters may be stored in the operation information DB 2.

If the operation information acquisition unit 11 acquires operation information of a plurality of existing systems from the operation information DB 2, the performance evaluation unit 13 can calculate parameters corresponding to modules of the undeveloped portion by, for example, either the following method (1) or (2). (1) The performance evaluation unit 13 calculates an average value for each parameter, and uses the average value as a parameter corresponding to a module of the undeveloped portion. (2) The performance evaluation unit 13 selects the worst value (the maximum value or the minimum value) for each parameter, and uses the worst value as a parameter corresponding to a module of the undeveloped portion.

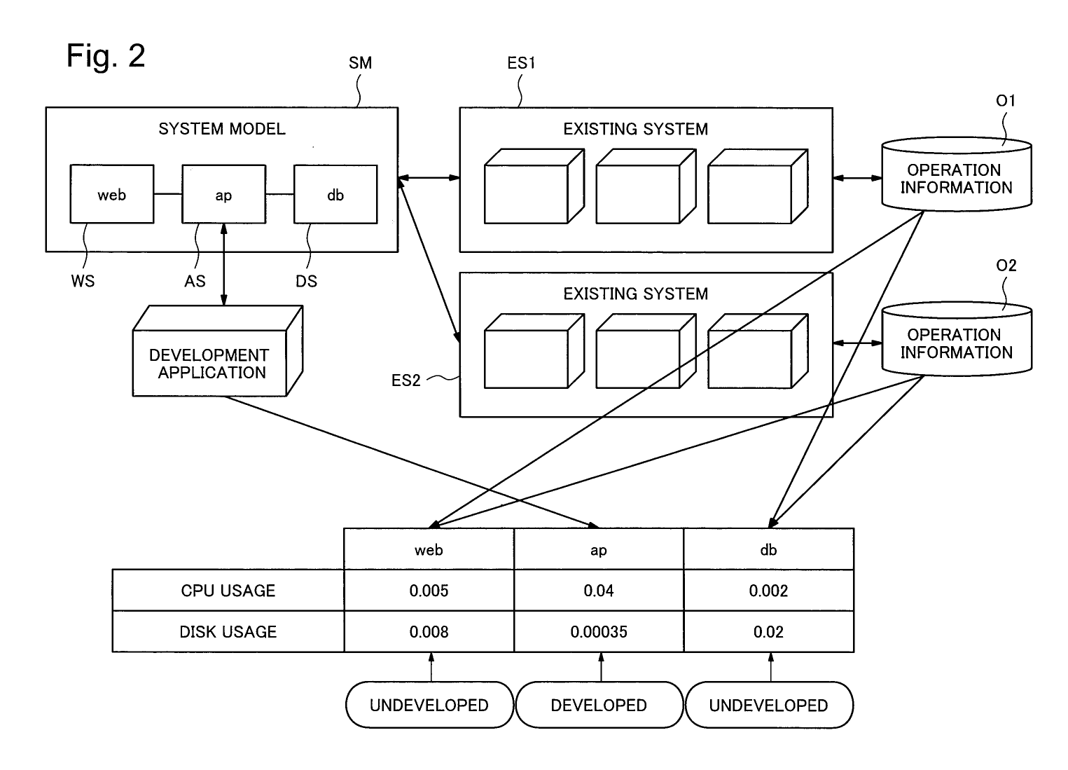

Referring to FIG. 2, the overview of the performance evaluation that is performed by the performance evaluation device 1 will be described.

A system model SM illustrated in FIG. 2 is a system model of a system to be evaluated. The system model SM includes a web server WS, an ap server AS, and a db server DS.

At this point, it is assumed that the modules of the ap server AS are already developed and the modules of the web server WS and db server DS are not developed yet.

The existing systems ES1 and ES2 are existing information systems that are constructed by using a system model identical to the system model SM. The operation information O1 of the existing system ES 1 and the operation information O2 of the existing system ES2 are stored in the operation information DB 2.

Conventionally, the system to be evaluated cannot be evaluated in such a condition. This is because, without developed modules of the web server WS and db server DS, the parameters of the modules of the web server WS and db server DS (for example, CPU usage, DISK usage) cannot be acquired.

Whereas, the performance evaluation device 1 according to the present exemplary embodiment calculates parameters of the modules of the web server WS and db server DS (for example, CPU usage, DISK usage) by using the operation information O1 and O2 of the existing systems ES1 and ES2.

As an example of the calculation method, for example, parameters of modules corresponding to the undeveloped modules in the system model are extracted from the operation information of an existing system among the existing systems that are developed based on the same system model. For example, if an undeveloped module is “web” in the system model, the CPU time and the like of the existing system that corresponds to “web” are extracted. In this case, if there are a plurality of such existing systems, a representative value is calculated. The representative value may be, for example, an average value, a worst value, or the like.

Even if modules of the web server WS and db server DS are not developed yet, this makes it possible to evaluate the performance of the system to be evaluated in the same way as evaluating the completed information system.

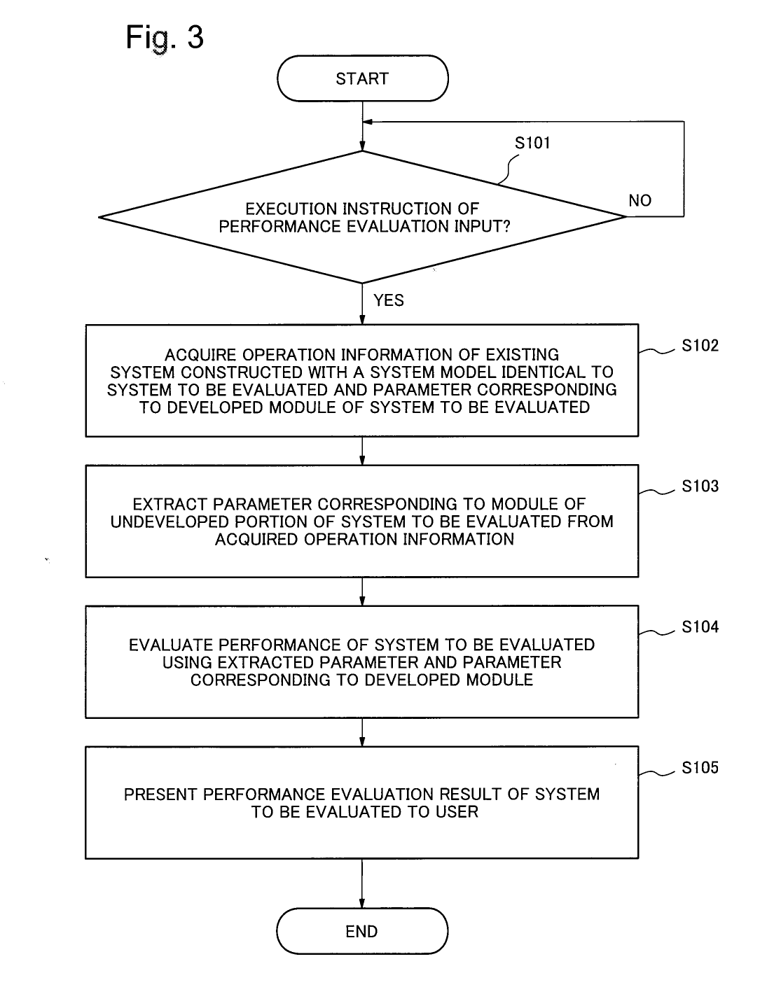

Next, referring to FIG. 3, the operation of the performance evaluation device 1 will be described.

FIG. 3 is a flowchart for describing a procedure of evaluating the performance of an information system.

First, the operation information acquisition unit 11 determines whether a user input an execution instruction of a performance evaluation (step S101). If the determination is NO (step S101; NO), the operation information acquisition unit 11 waits until it becomes YES.

On the other hand, if an execution instruction of a functional requirement and performance evaluation is determined as being input in the determination at the above-described step S101 (step S101; YES), the operation information acquisition unit 11 acquires the operation information from the operation information DB 2 on the basis of the system model of the system to be evaluated. The operation information is operation information of an existing system that is constructed by using a system model identical to the system model of the system to be evaluated. The input and output unit 14 acquires parameters corresponding to the developed modules from the system to be evaluated (for example, application CPU usage: 0.04) and outputs the parameters to the performance evaluation unit 13 (step S102).

Next, the undeveloped portion extraction unit 12 extracts parameters corresponding to the modules of the undeveloped portion, among the modules to be incorporated into the system to be evaluated, from operation information of the existing system acquired at the above-described step S102 (step S103). The parameters corresponding to the undeveloped portion modules are, for example, web CPU usage: 0.005 and database CPU usage: 0.002 that are operation information of the existing system ES1 as illustrated in FIG. 2. If there are a plurality of existing models, the average value or the worst value may be used.

Next, the performance evaluation unit 13 evaluates the performance of the system to be evaluated by using parameters extracted at the above-described step S103 and parameters corresponding to the developed modules of the system to be evaluated (step S104). The parameters extracted at the above-described step S103 are, for example, web CPU usage: 0.005 and database CPU usage: 0.002. The parameter corresponding to the developed module of the system to be evaluated is, for example, an application CPU usage: 0.04.

The evaluation processing at step S104 evaluates, for example, the performance of the system to be evaluated by using products, such as Queuing Network Simulator and Hyperformix (http://www.cmsinc.co.jp/techinfo/ssd01.html). As the products are known, the details thereof will not be described herein.

Subsequently, the performance evaluation unit 13 presents the performance evaluation result of the system to be evaluated to a user as the result of the evaluation at the above-described step S104 (step S105).

In this case, for example, each CPU usage “web CPU: 5%, database CPU usage: 2%, application CPU usage: 40%” and average CPU usage: 15% are presented to a user as a performance evaluation result.

As described above, according to the performance evaluation device 1 of the present exemplary embodiment, the operation information acquisition unit 11 acquires operation information of an existing system that is constructed by using a system model identical to the system model of the system to be evaluated from the operation information DB 2. The undeveloped portion extraction unit 12 extracts parameters corresponding to modules of the undeveloped portion, among the modules to be incorporated into the system to be evaluated, from the acquired operation information of the existing system. The performance evaluation unit 13 can evaluate the performance of the system to be evaluated by using the extracted parameters and parameters corresponding to the developed modules of the system to be evaluated.

Even if there are undeveloped modules in the system to be evaluated, this makes it possible to extract parameters corresponding to the modules of the undeveloped portion from the operation information of the existing system that is constructed by using the same system model. Then, the performance of the system to be evaluated can be evaluated by combining the extracted parameters and parameters corresponding to the developed modules.

In addition, as it is not necessary to execute the system to be evaluated or the existing system upon evaluation of the performance thereof, the performance of the system to be evaluated can be evaluated even if, for example, the configurations of interfaces, middleware, and the like do not match between the system to be evaluated and the existing system.

Further, if there are a plurality pieces of operation information of an existing system, the performance can be evaluated by using the average value, the worst value, or the like for each parameter, thereby enhancing the precision of the performance evaluation.

Thus, according to the performance evaluation device 1 of the present exemplary embodiment, the performance of the information system including an undeveloped portion can be evaluated with precision.

Note that the above-described exemplary embodiment is only an example and is not intended to eliminate variations and adaptation of other techniques that are not explicitly described in the exemplary embodiment. In other words, the present invention can be implemented to be modified in various exemplary embodiments without departing from the spirit thereof.

For example, when acquiring operation information of an existing system from the operation information DB 2, the operation information acquisition unit 11 in the above-described exemplary embodiment acquires operation information of the existing system that is constructed by using a system model identical to the system model of the system to be evaluated. However, the acquisition condition for acquiring operation information is not limited to this.

For example, the operation information acquisition unit 11 may acquire operation information of the existing system that simultaneously satisfies the following two conditions from the operation information DB 2. First, the existing system is an existing system that is constructed by using a system model identical to the system model of the system to be evaluated. Second, the existing system has a similar service level requirement for determining a quality assurance level to be provided by the information system.

The service level requirement is a condition for determining a quality assurance level to be provided by the system that is planned to be constructed, including assurance levels of, for example, a throughput, maximum CPU usage, maximum disk usage, network usage, and TAT (Turn Around Time), and the like.

Further, the operation information acquisition unit 11 may acquire operation information of the existing system that simultaneously satisfies the following two conditions from the operation information DB 2. First, the existing system is an existing system that is constructed by using a system model identical to the system model of the system to be evaluated. Second, the existing system has a similar functional requirement for determining a role that the application plays.

The functional requirement is a condition for determining a role that the application plays including, for example, functions of data processing, data storing, image analyses, response creations, statistical processing, and inventory controls, and the like.

In this variation, when the operation information acquisition unit 11 acquires operation information of a plurality of existing systems, the performance evaluation unit 13 can calculate the parameters corresponding to the modules of the undeveloped portion by using, for example, the following method in addition to the above-described (1) or (2).

First, the performance evaluation unit 13 calculates the similarity to the service level requirements and functional requirements and determines weight coefficients in accordance with the similarity.

Next, the performance evaluation unit 13 calculates an average value for each parameter taking the weight coefficients into consideration and uses the average value as a parameter corresponding to a module of the undeveloped portion.

Further, for example, the performance evaluation device 1 may also input parameters required for the performance evaluation from the outside to the performance evaluation unit 13 by using the input and output unit 14 without using the operation information acquisition unit 11 or the undeveloped portion extraction unit 12. Then, the performance evaluation unit 13 may evaluate the performance of the information system by using the input parameters.

Further, for each of the above-described exemplary embodiments of the present invention, the processing functions that are described with reference to the flowchart can be realized by a computer. In such a case, there will be provided a program in which the processing contents of the functions that the performance evaluation device 1 should include are written.

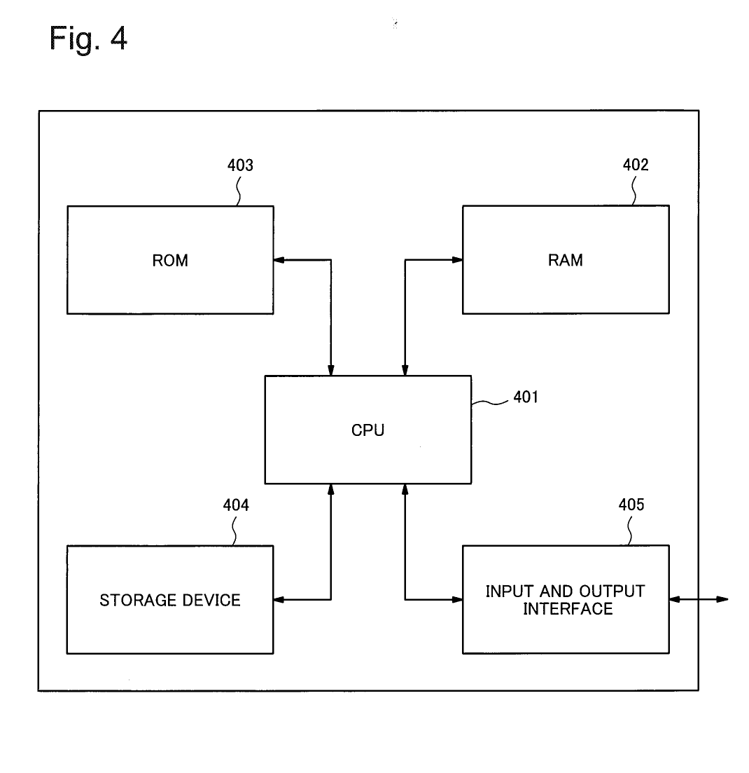

FIG. 4 is a block diagram illustrating an example of a hardware configuration of the performance evaluation device according to the exemplary embodiment of the present invention.

As illustrated in FIG. 4, the performance evaluation device 1 physically includes, for example, a CPU 401 (Central Processing Unit), a storage device 404, and an input and output interface 405. The storage device 404 includes, for example, a ROM 403 (Read Only Memory) and a HDD (Hard Disk Drive) that store a program and data to be processed by the CPU 401, a RAM 402 (Random Access Memory) that is mainly used as various work areas for control processing, and the like.

These components are connected to one another through a bus. The functions of the respective units in the performance evaluation device 1 are realized by the CPU 401 executing a program stored in the ROM 403 and processing messages received via the input and output interface 405 and data deployed on the RAM 402, and the like.

Further, this application claims priority based on Japanese Patent Application No. 2012-220619 filed on Oct. 2, 2012, the disclosure of which is incorporated herein in its entirety.

### INDUSTRIAL APPLICABILITY

The present invention is applicable, for example, to performance evaluations in development of information systems.

### REFERENCE SIGNS LIST

1 Performance evaluation device for information system
2 Operation information database (DB)
11 Operation information acquisition unit
12 Undeveloped portion extraction unit
13 Performance evaluation unit
14 Input and output unit
15 Keyboard
16 Mouse
17 Network
401 CPU
402 RAM
403 ROM
404 Storage device
405 Input and output interface

What is claimed is:

1. A performance evaluation device for an information system comprising:
an input and output unit; and
a performance evaluation unit,
wherein said performance evaluation unit evaluates performance of a system to be evaluated by using parameters corresponding to modules of an undeveloped portion of the system to be evaluated and parameters corresponding to developed modules of said system to be evaluated among modules to be incorporated into said system to be evaluated, from operation information of an existing system that is constructed with a system model identical to a system model of the system to be evaluated, the operation information being input via said input and output unit.

2. The performance evaluation device for the information system according to claim 1, further comprising:
an operation information acquisition unit that acquires the operation information of the existing system that is constructed with a system model identical to the system model of said system to be evaluated, from the operation information of an existing information system already constructed on the basis of the system model of said system to be evaluated; and
an undeveloped portion extraction unit that extracts parameters corresponding to the modules of the undeveloped portion, among the modules to be incorporated into said system to be evaluated, from the operation information of said existing system acquired by said operation information acquisition unit,
wherein, when an execution instruction of a performance evaluation is input, said performance evaluation unit evaluates performance of said system to be evaluated by using said parameters extracted from the undeveloped portion extraction unit and parameters corresponding to the developed modules of said system to be evaluated.

3. The performance evaluation device for the information system according to claim 2,
wherein, when acquiring the operation information of said existing system, said operation information acquisition unit acquires the operation information of said existing system that is said existing system constructed by using a system model identical to the system model of said system to be evaluated and of which service level requirement for determining a quality assurance level to be provided by the information system is similar to that of the system to be evaluated.

4. The performance evaluation device for the information system according to claim 2,
wherein, when acquiring the operation information of said existing system, said operation information acquisition unit acquires the operation information of said existing system that is said existing system constructed by using a system model identical to the system model of said system to be evaluated and of which functional requirement for determining a role that an application plays is similar to that of the system to be evaluated.

5. The performance evaluation device for the information system according to claim 2,
wherein, if said operation information acquisition unit acquires the operation information of a plurality of said existing systems, said performance evaluation unit uses an average value of said parameters extracted from the respective pieces of operation information when evaluating the performance of said system to be evaluated.

6. The performance evaluation device for the information system according to claim 2,
wherein, if said operation information acquisition unit acquires the operation information of a plurality of said existing systems, said performance evaluation unit uses a worst value of said parameters extracted from the respective pieces of operation information when evaluating the performance of said system to be evaluated.

7. A performance evaluation method for an information system comprising:
by an information processing device,
acquiring parameters corresponding to modules of an undeveloped portion of a system to be evaluated and parameters corresponding to developed modules of said system to be evaluated among modules to be incorporated into said system to be evaluated, from operation information of an existing system that is constructed with a system model identical to a system model of said system to be evaluated, and
evaluating performance of said system to be evaluated by using said acquired two parameters.

8. The performance evaluation method for the information system according to claim 7, comprising:
on the basis of the system model of the system to be evaluated that is the information system to be subjected to said performance evaluation, acquiring the operation information of said existing system that is constructed by using a system model identical to the system model of the system to be evaluated, from the operation information of the existing system that is an information system already constructed;
extracting parameters corresponding to the modules of the undeveloped portion among the modules to be incorporated into said system to be evaluated, from the operation information of said acquired existing system; and
when an execution instruction of a performance evaluation is input, evaluating performance of said system to be evaluated by using said extracted parameters and the parameters corresponding to the developed modules of said system to be evaluated.

9. The performance evaluation method for the information system according to claim 8,
wherein, when acquiring the operation information of said existing system in the acquisition of said operation information, acquired is the operation information of said existing system that is said existing system constructed by using a system model identical to the system model of said system to be evaluated and of which service level requirement for determining a quality assurance level to be provided by the information system is similar to that of the system to be evaluated.

10. The performance evaluation method for the information system according to claim 8,
wherein, when acquiring the operation information of said existing system in the acquisition of said operation information, acquired is operation information of said existing system that is said existing system constructed by using a system model identical to the system model of said system to be evaluated and of which functional requirement for determining a role that an application plays is similar to that of the system to be evaluated.

11. The performance evaluation method for the information system according to claim 8,
wherein, if the operation information of a plurality of said existing systems is acquired in the acquisition of said operation information, an average value of said parameters extracted from the respective pieces of operation information is used upon evaluation of the performance of said system to be evaluated.

12. The performance evaluation method for the information system according to claim 8,
wherein, if the operation information of a plurality of said existing systems is acquired in the acquisition of said operation information, a worst value of said parameters extracted from the respective pieces of operation information is used upon evaluation of the performance of said system to be evaluated.

13.-18. (canceled)

19. A non-transitory computer-readable recording medium that stores a program causing a computer to execute the processing of:
acquiring parameters corresponding to modules of an undeveloped portion of a system to be evaluated and parameters corresponding to developed modules of said system to be evaluated among modules to be incorporated into said system to be evaluated, from operation information of an existing system that is constructed with a system model identical to a system model of said system to be evaluated; and
evaluating performance of said system to be evaluated by using said acquired two parameters.
